(19) United States
(12) Patent Application Publication
(10) Pub. No.: US 2025/0246997 A1
(43) Pub. Date: Jul. 31, 2025

(54) SWITCHING POWER SUPPLY DEVICE

(71) Applicant: COSEL CO., LTD., Toyama-shi,Toyama (JP)

(72) Inventors: Sota MIZUSHIMA, Toyama-shi, Toyama (JP); Tetsuro HIRATA, Toyama-shi, Toyama (JP); Masashi MAKI, Toyama-shi, Toyama (JP); Yuhei SUGIMORI, Toyama-shi, Toyama (JP)

(73) Assignee: COSEL CO., LTD., Toyama-shi,Toyama (JP)

(21) Appl. No.: 18/880,873

(22) PCT Filed: Jun. 17, 2024
(86) PCT No.: PCT/JP2024/021922

§ 371 Date: Jan. 3, 2025

(30) Foreign Application Priority Data
Sep. 11, 2023 (JP) 2023-147073
Oct. 18, 2023 (JP) 2023-179268

(51) Int. Cl. H02M 1/44; H02M 7/00

(52) U.S. Cl. CPC H02M 1/44; H02M 7/003

(57) ABSTRACT

A switching power supply device in which lead wires of a capacitor element have tip portions connected to a printed wiring board, and a space between lead wires serves as a magnetic flux passage space for a leakage magnetic flux emitted from a power conversion circuit. An electromagnetic shield member is provided with a shield portion having a metal frame body and a penetration region inside the frame body. The leakage magnetic flux acts on the shield portion, and a current flows in the circumferential direction of the frame body, thereby generating a magnetic field in a direction of canceling the leakage magnetic flux, and suppressing a magnetic flux density of the leakage magnetic flux passing through the magnetic flux passage space.

### TECHNICAL FIELD

The present invention relates to a switching power supply device having a shield portion that suppresses noise caused by a leakage magnetic flux emitted by a switching operation.

### BACKGROUND ART

Conventionally, for example, as disclosed in Patent Literature 1 filed by the applicant of the present application, there is a switching power supply device having a structure in which a pair of connection patterns connecting an output-side smoothing capacitor and an output terminal three-dimensionally intersect with each other. In general, a loop formed by the smoothing capacitor and the connection pattern becomes large, a leakage magnetic flux from a magnetic component interlinks with the loop, a large induced current flows, and a large noise voltage is generated in the connection pattern or the like, thereby adversely affecting an external load or the like. However, according to the structure of the switching power supply device, the induced current can be reduced, and the generation of the noise voltage can be suppressed.

### CITATION LIST

### Patent Literature

Patent Literature 1: Japanese Utility Model Registration No. 3142501

### SUMMARY OF THE INVENTION

### Problems to be Solved by the Invention The structure of Patent Literature 1 is very excellent in suppressing the

generation of the noise voltage due to the leakage magnetic flux. However, when a lead wire of the smoothing capacitor is long, an effect of suppressing the generation of the noise voltage in the lead wire cannot be expected.

For example, in a conventional switching power supply device 10 illustrated in FIG. 6, a power conversion circuit 14 is mounted on a printed wiring board 12, and a capacitor element 18, which is a component with leads, is mounted in the vicinity of a magnetic component 16, which is a component of the power conversion circuit 14. The capacitor element 18 has a cylindrical component body 20 disposed horizontally, and a pair of lead wires 22a and 22b extend from an end portion of the component body 20 toward the printed wiring board 12, and tip portions of the lead wires 22a and 22b are connected to a wiring pattern on the printed wiring board. The reason why the lead wires 22a and 22b are long is that a circuit component (not illustrated) is mounted below the component body 20, and by making the lead wires 22a and 22b long, the component body 20 is prevented from coming into contact with the circuit component below. Therefore, a loop is formed by the lead wires 22a and 22b rising from the printed wiring board 12. Hereinafter, a space between the lead wires 22a and 22b is referred to as a magnetic flux passage space 24.

The power conversion circuit 14 is a circuit that performs power conversion by a switching operation. The magnetic component 16 is, for example, a switching transformer, a power inductor, or the like, and emits a leakage magnetic flux o when performing a switching operation. A part of the leakage magnetic flux q passes through the magnetic flux passage space 24 of the capacitor element 18, an induced current flows in the lead wires 22a and 22b, a large noise voltage is generated in the lead wires 22a and 22b, which may adversely affect an external load or the like. This problem cannot be solved even by using the structure of Patent Literature 1.

Although the capacitor element 18 illustrated in FIG. 6 is a smoothing aluminum electrolytic capacitor or the like, even in a case of a small-sized capacitor element (ceramic capacitor or film capacitor) used in a control circuit, a resistor element having a very small resistance value, or the like, when the lead wire is long, there is a possibility that the above noise voltage is generated, and the control circuit malfunctions.

The present invention has been made in view of the above-described background art, and it is an object of the present invention to provide a switching power supply device that can easily suppress the generation of a noise voltage due to a leakage magnetic flux from a power conversion circuit acting on a lead wire of a component with leads.

### Means for Solving the Problem

The present invention is a switching power supply device including: a printed wiring board: a power conversion circuit that is mounted on the printed wiring board and that performs power conversion by a switching operation: a component with leads that is a component in the power conversion circuit or a component other than the power conversion circuit and that includes a pair of lead wires extending in the same direction from an end portion of a component body: and an electromagnetic shield member formed in an annular shape and having a shield portion formed of an electrically closed conductor frame body whose inner side is a penetration region through which a magnetic line of force can pass, and the lead wire of the component with leads has a tip portion connected to a wiring pattern of the printed wiring board and rises from the printed wiring board, and a space between a pair of the lead wires serves as a magnetic flux passage space for a leakage magnetic flux emitted from the power conversion circuit, and in a state where the electromagnetic shield member is mounted on the printed wiring board, the shield portion is positioned in such a way that the leakage magnetic flux can pass through the penetration region and the leakage magnetic flux passing through the penetration region passes through the magnetic flux passage space, the leakage magnetic flux acts on the shield portion, a magnetic field in a direction in which the leakage magnetic flux is canceled is generated by a current flowing in a circumferential direction of the frame body, and a magnetic flux density of the leakage magnetic flux passing through the magnetic flux passage space is suppressed.

The shield portion is positioned in such a way that a plane formed by the frame body and the magnetic flux passage space face each other in parallel, and a central axis orthogonal to the plane and passing through the center of the penetration region passes through the magnetic flux passage space.

At least a part of the frame body of the electromagnetic shield member is constituted of a metal plate. Further, the frame body of the electromagnetic shield member may be formed of a metal plate, and may have a fitting portion to be inserted into and fixed to a through hole of the printed wiring board, the fitting portion being integrally provided in a protruding manner. In the electromagnetic shield member, a heat dissipation portion for dissipating heat of a circuit component may be integrally provided at an end portion of the shield portion.

A part of the frame body of the electromagnetic shield member is formed by a wiring pattern of the printed wiring board. Alternatively, the frame body of the electromagnetic shield member may be formed by a wiring pattern of an auxiliary printed wiring board separate from the printed wiring board. The auxiliary printed wiring board may have a fitting portion to be inserted into and fixed to a through hole of the printed wiring board, the fitting portion being integrally provided in a protruding manner. The component with leads is, for example, a capacitor element.

### Effect of the Invention

Since the switching power supply device according to the present invention includes an electromagnetic shield member having a shield portion with a unique structure, when a leakage magnetic flux acts on the shield portion, a current flows in the circumferential direction of the electromagnetic shield member, thereby generating a magnetic field in a direction in which the leakage magnetic flux is canceled. Thus, the magnetic flux density of the leakage magnetic flux passing through the magnetic flux passage space can be effectively suppressed, and the noise voltage generated in the lead wire can be effectively suppressed.

### BRIEF DESCRIPTION OF THE DRAWINGS

FIG. 1 is a perspective view illustrating an embodiment of a switching power supply device according to the present invention.

FIG. 2 illustrates perspective views (a) to (c) illustrating three specific examples of an electromagnetic shield member of FIG. 1.

FIG. 3 is a circuit diagram illustrating an internal circuit of a prototype of the switching power supply device of this embodiment and an external connection circuit of an effect confirmation experiment performed by using this prototype.

FIG. 4 illustrates graphs (a) to (c) illustrating results of effect confirmation experiment and illustrating measurement results of frequency characteristics of noise terminal voltages of comparative examples A and B and the prototype, respectively, and line graphs (d) to (f) comparing voltage levels of specific frequencies.

FIG. 5 illustrates a front view (a) illustrating a modified example of the electromagnetic shield member, and a perspective view (b) illustrating an other modified example.

FIG. 6 is a perspective view illustrating one form of a conventional switching power supply device.

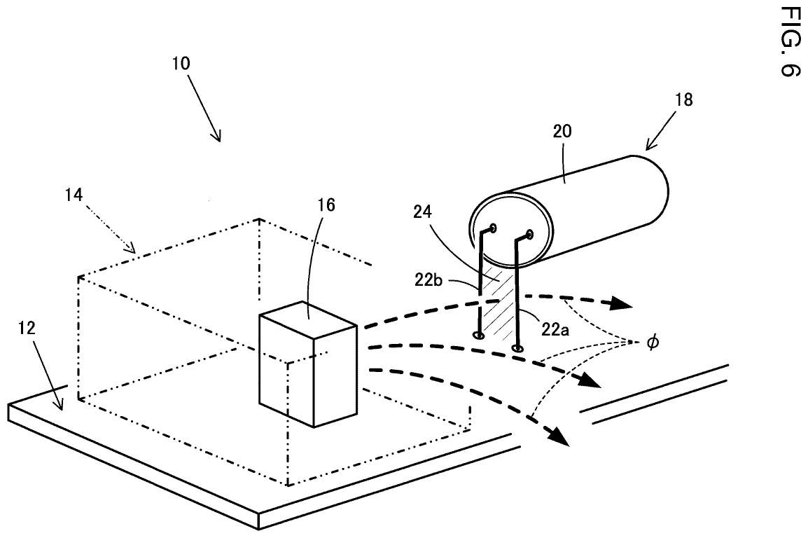

### MODE FOR CARRYING OUT THE INVENTION

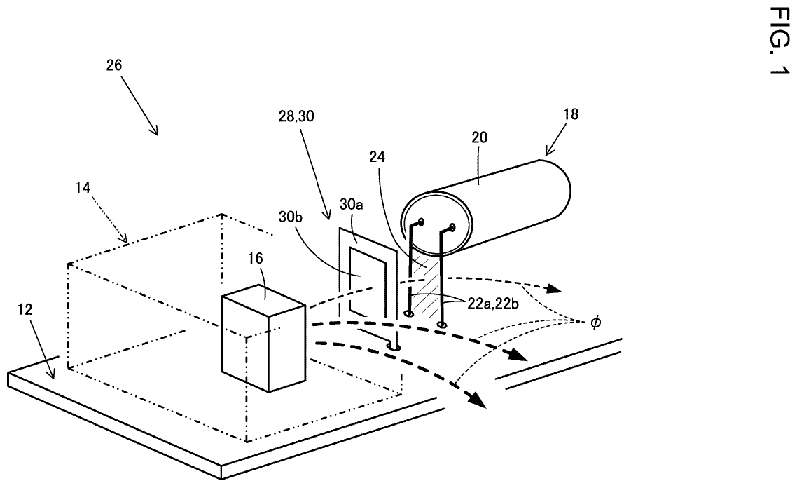

Hereinafter, an embodiment according to a switching power supply device of the present invention will be described with reference to FIGS. 1 to 4. Herein, the same component as that of the conventional switching power supply device 10 is denoted by the same reference numeral, and the description thereof is omitted.

As illustrated in FIG. 1, a switching power supply device 26 according to this embodiment has the same configuration as that of the above-described switching power supply device 10 except that an electromagnetic shield member 28 is additionally mounted on the switching power supply device 10.

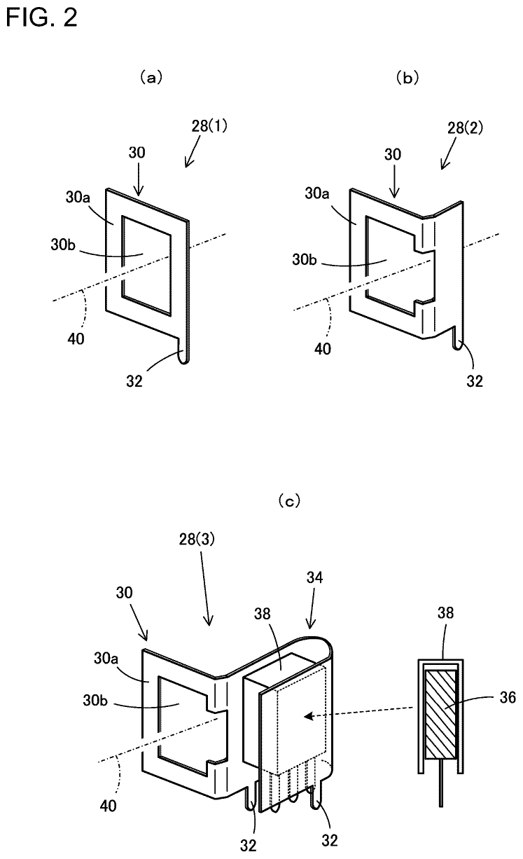

Specifically, the electromagnetic shield member 28 may have a structure as illustrated in FIGS. 2A to 2C. An electromagnetic shield member 28(1) illustrated in (a) in FIG. 2 has the simplest structure that can be manufactured by punching a flat metal plate, and has a shield portion 30 composed of an annularly closed flat frame body 30a and a penetration region 30b inside the frame body 30a, and at a lower end portion of the shield portion 30, a fitting portion 32 to be inserted into and fixed to a through hole or the like of a printed wiring board 12 is integrally provided in a protruding manner.

An electromagnetic shield member 28(2) illustrated in FIG. 2B has a structure acquired by punching a flat metal plate and then bending a side end portion thereof, and has a shield portion 30 composed of a frame body 30a closed in an annular shape and slightly bent in an L-shape and a penetration region 30b inside the frame body 30a. At a lower end portion of the shield portion 30, a fitting portion 32 to be inserted into and fixed to a through hole or the like of the printed wiring board 12 is integrally provided in a protruding manner.

In an electromagnetic shield member 28(3) illustrated in FIG. 2C, the side end portion of the shield portion 30 of the electromagnetic shield member 28(2) is extended in a U-shape, thereby providing a heat dissipation portion 34. The heat dissipation portion 34 sandwiches a heat generating component 36 (or a heat generating circuit module) covered with a heat dissipation cap 38 made of silicon from both sides, and serves to release heat of the heat generating component 36 (or the heat generating circuit module).

As illustrated in FIG. 1, the electromagnetic shield member 28 is mounted on the printed wiring board 12, and positioned in such a way that the shield portion 30 is arranged in the vicinity of lead wires 22a and 22b of a capacitor element 18, a plane formed by the frame body 30a and a magnetic flux passage space 24 face each other in parallel, and a central axis 40 perpendicular to the plane and passing through the center of the penetration region 30b passes through substantially the center of the magnetic flux passage space 24.

In an action of the electromagnetic shield member 28, when a leakage magnetic flux φ emitted from a magnetic component 16 passes through the penetration region 30b inside the frame body 30a of the shield portion 30, eddy current flows in the circumferential direction of the frame body 30a. Thus, a magnetic field in a direction of canceling the leakage magnetic flux φ is generated in the shield portion 30, a magnetic flux density of the leakage magnetic flux φ in the magnetic flux passage space 24 facing the frame body 30a is suppressed, and noise voltage generated in the lead wires 22a and 22b can be effectively suppressed.

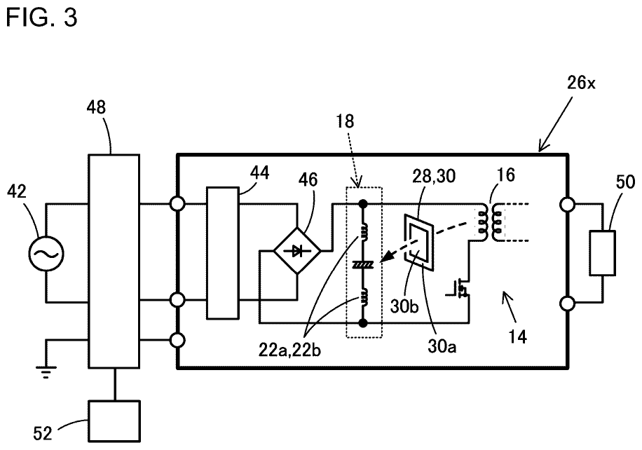

In order to confirm the effect of the electromagnetic shield member 28, the inventor has manufactured a prototype 26x of the switching power supply device 26 of the present invention, and has conducted an experiment of measuring a noise level (noise terminal voltage) fed back from the prototype 26x to an input power supply 42 side by a measurement circuit illustrated in FIG. 3.

An internal circuit of the prototype 26x is configured such that an AC input voltage being output from the input power supply 42 is received by a noise filter 44, rectified and smoothed by a rectifier element 46 and the capacitor element 18, and input to the power conversion circuit 14 (DC-DC converter) that performs a switching operation. The magnetic component 16 and the capacitor element 18 have a positional relationship in which a part of the leakage magnetic flux φ emitted from the magnetic component 16 easily passes through the magnetic flux passage space 24 of the capacitor element 18. As illustrated in FIG. 1, the electromagnetic shield member 28 is arranged in the vicinity of the lead wires 22a and 22b of a capacitor element 24. The shield portion 30 is positioned in such a way that the central axis 40 of the penetration region 30b passes through substantially the center of the magnetic flux passage space 24.

As illustrated in FIG. 3, a connection between the prototype 26x of the switching power supply device 26 and the measurement circuit has been achieved by inserting a pseudo power supply circuit network 48 for impedance matching between the input power supply 42 and an input end of the prototype 26x, and connecting a load 50 that consumes predetermined power to an output end of the prototype 26x. A spectrum analyzer 52 has been connected to the pseudo power supply circuit network 48, and a frequency characteristic of the noise terminal voltage has been measured.

For comparison, a switching power supply device [a comparative example (A)] in which the shield portion 30 is removed from the electromagnetic shield member 28 by changing the electromagnetic shield member 28 of the prototype 26x and a switching power supply device [a comparative example (B)] formed into a simple flat plate by eliminating the penetration region 30b of the shield portion 30 have been manufactured, and the same measurement has been performed.

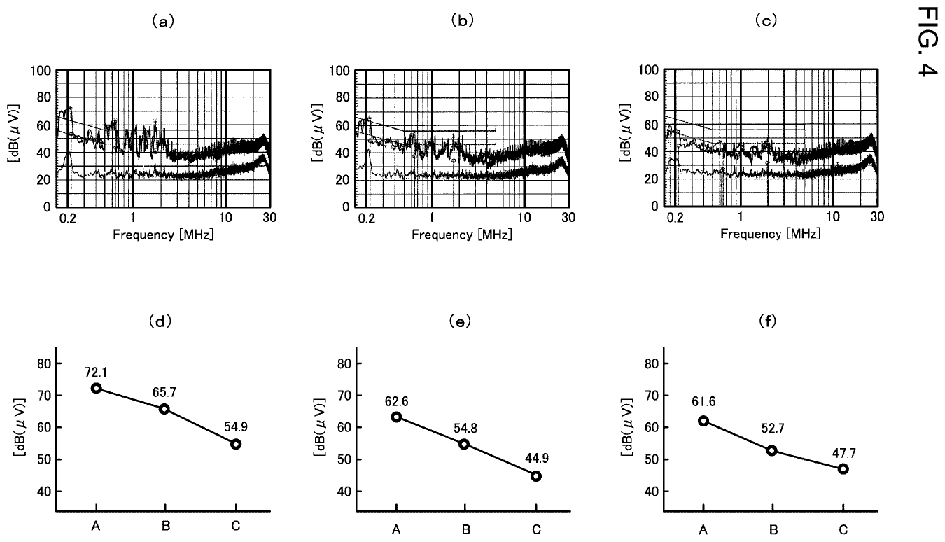

FIGS. 4(a) to 4(c) illustrate frequency characteristics of noise terminal voltages measured by the spectrum analyzer 52 for the comparative example (A), the comparative example (B), and the prototype 26x, and the prototype 26x illustrated in FIG. 4(c) has the best characteristics. Further, as illustrated in FIG. 4 (d), looking at a peak voltage level of the noise terminal voltage near 210 kHz, the comparative example (A) is 72.1 dBμV, the comparative example (B) is 65.7 dBμV, and the prototype 26x (C) is 54.9 dBμV, and the voltage level of the prototype 26x (C) is the lowest. As illustrated in FIG. 4(e), looking at a peak voltage level of the noise terminal voltage near 650 kHz, the comparative example (A) is 62.6 dBμV, the comparative example (B) is 54.8 dBμV, and the prototype 26x (C) is 44.9 dBμV, and the voltage level of the prototype 26x (C) is the lowest. Further, as illustrated in FIG. 4 (f), looking at a peak voltage level of the noise terminal voltage near 2 MHz, the comparative example (A) is 61.6 dBμV, the comparative example (B) is 52.7 dBμV, and the prototype 26x (C) is 47.7 dBμV, and the voltage level of the prototype 26x (C) is the lowest.

When the measurement results of the comparative example (A) and the comparative example (B) are compared, it is found that a certain shielding effect can be acquired only by providing the shield portion 30 formed of a simple flat plate. This is considered that an eddy current flows in the shield portion 30, a magnetic field in a direction of canceling the leakage magnetic flux φ passing through the magnetic flux passage space 24 of the capacitor element 18 is generated, the magnetic flux density of the leakage magnetic flux φ passing through the magnetic flux passage space 24 is suppressed to some extent by the magnetic field in the canceling direction, and this, the noise terminal voltage has been reduced.

When the measurement results of the comparative example (B) and the prototype 26x are compared, it is found that the shield effect is further improved by providing the penetration region 30b in the shield portion 30. In the comparative example (B), since the penetration region 30b is not provided, the eddy current flowing through the shield portion 30 is small, and it is difficult to effectively generate the magnetic field in the canceling direction. On the other hand, in the prototype 26x, the shield portion 30 is provided with the penetration region 30b, and the central axis 40 of the penetration region 30b is positioned in such a way as to pass through the magnetic flux passage space 24 of the capacitor element 18. Therefore, eddy currents are restricted to flow along the circumferential direction of the frame body 30a, a magnetic field in a direction of canceling the leakage magnetic flux φ is generated in the shield portion 30, and the magnetic flux density of the leakage magnetic flux φ in the magnetic flux passage space 24 is effectively suppressed. As a result, it is considered that the noise terminal voltage has been greatly reduced.

In the prototype 26x, as illustrated in FIG. 1, the magnetic component 16, the shield portion 30, and the magnetic flux passage space 24 are arranged in this order when viewed from the side close to the magnetic component 16. However, even when the order of the magnetic component 16, the magnetic flux passage space 24, and the shield portion 30 is changed, substantially the same effect can be acquired based on the same principle as described above.

As described above, the switching power supply device 26 includes the electromagnetic shield member 28 having the shield portion 30 with a unique structure, and the shield portion 30 is constituted by the metal frame body 30a and the penetration region 30b inside the frame body 30a. Therefore, when the leakage magnetic flux φ acts on the shield portion 30, an eddy current flows in the circumferential direction of the frame body 30a, thereby generating a magnetic field in a direction of canceling the leakage magnetic flux φ, and the magnetic field can effectively act on the magnetic flux passage space 24. Thus, the magnetic flux density of the leakage magnetic flux φ passing through the magnetic flux passage space 24 is effectively suppressed, and the problem that noise voltage is generated in the lead wires 22a, 22b can be easily solved.

The switching power supply device according to the present invention is not limited to the above-described embodiment. For example, the structures of the electromagnetic shield members 28(1) to 28(3) illustrated in FIGS. 2(a) to (c) are preferable examples, and can be appropriately changed in accordance with the actual structure of the power supply device.

The shield portion of the electromagnetic shield member is not limited to the structure of the shield portion 30 described above as long as the shield portion is constituted by a frame body of a conductor electrically closed in an annular shape and a penetration region inside the frame body. For example, the shapes of the frame body and the penetration region may be changed to a shape other than the quadrangular shape. Note that the “penetration region” in the present invention includes not only a space where no physical member exists as in the above-described embodiment, but also a region where an insulating member through which a magnetic line of force can pass exists. This is because the insulating member is equivalent to air with respect to electromagnetic waves, and hardly affects the performance of the shield portion.

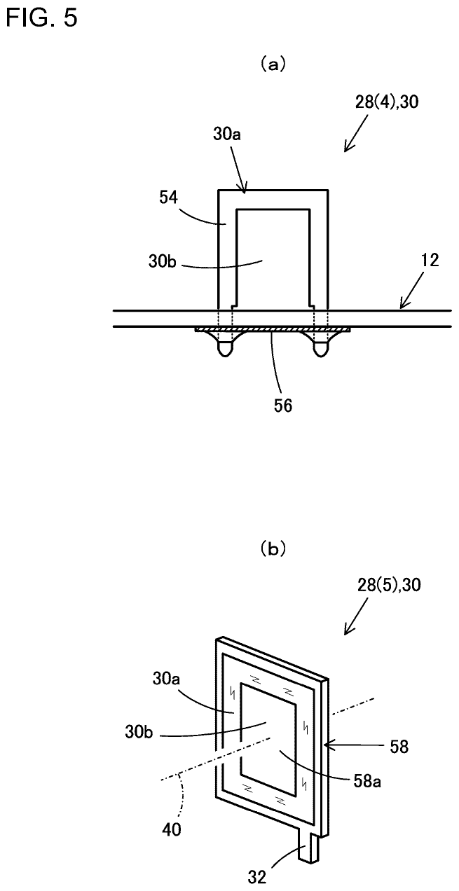

In addition, the electromagnetic shield member may have a structure similar to that of an electromagnetic shield member 28(4) illustrated in FIG. 5(a). A shield portion 30 of the electromagnetic shield member 28(4) is provided with a U-type metallic member 54 which is partially opened in the circumferential direction, and both end portions of the U-type metallic member 54 are connected to a wiring pattern 56 of the printed wiring board 12 and short-circuited. In this embodiment, a frame body 30a is formed of the U-type metallic member 54 and the wiring pattern 56, and a penetration region 30b is formed inside the frame body 30a. Even when the structure is changed to such a structure, substantially the same action effect can be acquired.

The electromagnetic shield member may have a structure like an electromagnetic shield member 28(5) illustrated in FIG. 5(b). The electromagnetic shield member 28(5) is formed by using an auxiliary printed wiring board 58 separate from the printed wiring board 12. A base material 58a of the printed wiring board 58 is an insulator such as glass epoxy or paper phenol. In a shield portion 30, a frame body 30a is formed by a wiring pattern laid out in an annular shape, and the inside of this wiring pattern becomes a penetration region 30b. In the case of the electromagnetic shield member 28(5), the penetration region 30b is formed by the base material 58a, but since the base material 58a is an insulator, the magnetic lines of force can penetrate therethrough, and shielding performance is hardly affected. Even when the structure is changed to such a structure, substantially the same action effect can be acquired.

In addition, the material of the frame body of the shield portion may be a conductor such as a metal, and can be appropriately selected from aluminum, copper, brass, phosphor bronze, iron, and the like, which are widely used as a shield case or the like, and substantially the same effect can be acquired. Further, the type and use of the component with leads that is subject to electromagnetic shielding are not particularly limited, and in addition to the above-described smoothing capacitor element, for example, a small-sized capacitor element used in a control circuit, a resistor element having a very small resistance value, and the like can be targeted. In particular, an excellent effect can be acquired when an element whose main impedance (impedance of a portion other than the lead wire) is extremely low in a high frequency band is targeted.

### DESCRIPTION OF REFERENCE NUMERALS

10, 26 switching power supply device
12 printed wiring board
14 power conversion circuit
18 capacitor element (component with leads)
20 component body
22a, 22b lead wires
24 magnetic flux passage space
26x prototype
28, 28(1) to 28(5) electromagnetic shield member
30 shield portion
30a frame body
30b penetration region
32 fitting portion
34 heat dissipation portion
36 heat generating component
38 heat dissipation cap
40 central axis
42 input power supply
44 noise filter
46 rectifier element
48 pseudo power supply circuit network
50 load
52 spectrum analyzer
54 U-type metallic member (frame body)
56 wiring pattern (frame body)
58 auxiliary printed wiring board
58a base material
leakage magnetic flux

1. A switching power supply device comprising:
a printed wiring board;
a power conversion circuit that is mounted on the printed wiring board and that performs power conversion by a switching operation;
a component with leads that is one component in the power conversion circuit or a component other than the power conversion circuit and that includes a pair of lead wires extending in a same direction from an end portion of a component body; and
an electromagnetic shield member formed in an annular shape and having a shield portion formed of an electrically closed conductor frame body whose inner side is a penetration region through which a magnetic line of force can pass,
wherein:
the lead wires of the component with leads have tip portions connected to a wiring pattern of the printed wiring board and rise from the printed wiring board,
a space between the pair of lead wires serves as a magnetic flux passage space for a leakage magnetic flux emitted from the power conversion circuit,
in a state where the electromagnetic shield member is mounted on the printed wiring board, the shield portion is positioned in such a way that the leakage magnetic flux can pass through the penetration region and the leakage magnetic flux passing through the penetration region passes through the magnetic flux passage space, and
the leakage magnetic flux acts on the shield portion, a magnetic field in a direction in which the leakage magnetic flux is canceled is generated by a current flowing in a circumferential direction of the frame body, and a magnetic flux density of the leakage magnetic flux passing through the magnetic flux passage space is suppressed.

2. The switching power supply device according to claim 1, wherein the shield portion is positioned in such a way that a plane formed by the frame body and the magnetic flux passage space face each other in parallel, and a central axis orthogonal to the plane and passing through a center of the penetration region passes through the magnetic flux passage space.

3. The switching power supply device according to claim 1, wherein at least a part of the frame body of the electromagnetic shield member is formed of a metal plate.

4. The switching power supply device according to claim 3, wherein the frame body of the electromagnetic shield member is formed of a metal plate, and has a fitting portion to be inserted into and fixed to a through hole of the printed wiring board, the fitting portion being integrally provided in a protruding manner.

5. The switching power supply device according to claim 4, wherein the electromagnetic shield member is integrally provided with a heat dissipation portion for dissipating heat of a circuit component, at an end portion of the shield portion.

6. The switching power supply device according to claim 1, wherein a part of the frame body of the electromagnetic shield member is formed by a wiring pattern of the printed wiring board.

7. The switching power supply device according to claim 1, wherein the frame body of the electromagnetic shield member is formed by a wiring pattern of an auxiliary printed wiring board that is separate from the printed wiring board.

8. The switching power supply device according to claim 7, wherein the auxiliary printed wiring board has a fitting portion to be inserted into and fixed to a through hole of the printed wiring board, the fitting portion being integrally provided in a protruding manner.

9. The switching power supply device according to claim 1, wherein the component with leads is a capacitor element.
